(19) United States
(12) Patent Application Publication
(10) Pub. No.: US 2015/0363320 A1
(43) Pub. Date: Dec. 17, 2015

(54) WRITE BACK CACHING OF BOOT DISK IN A UEFI ENVIRONMENT

(71) Applicant: LSI Corporation, San Jose, CA (US)

(72) Inventors: Amit Kumar, Bangalore (IN); Pradeep R. Venkatesha, Bangalore (IN)

(21) Appl. No.: 14/306,555

(22) Filed: Jun. 17, 2014

(51) Int. Cl. G06F 12/08; G06F 12/02

(52) U.S. Cl. CPC G06F 12/0871; G06F 12/0246; G06F 2212/7201; G06F 2212/604

(57) ABSTRACT

Write back caching of Operating System (OS) boot data in a UEFI environment is disclosed. One embodiment is an apparatus that includes a non-volatile memory, a storage device, and a processor. The non-volatile memory caches boot data for an OS. The storage device stores the OS. The processor receives a write request for the storage device, and determines whether the write request modifies boot data accessed within a UEFI pre-OS boot environment. The processor directs the write request to the storage device responsive to determining that the write request modifies boot data accessed within the UEFI pre-OS boot environment, and directs the write request to the non-volatile memory responsive to determining that the write request does not modify boot data accessed within the UEFI pre-OS boot environment.

### FIELD OF THE INVENTION

The invention generally relates to field of computing devices that utilize write back caching of boot data.

### BACKGROUND

Disk caching is often utilized in computing devices to reduce the amount of time before a user has access to an operating system that is stored on a slower access medium, such as a hard disk drive. While the typical computing device that utilizes write back caching is the personal computer, other computing devices such as tablets, smart phones, etc., have risen in popularity in recent years and in some cases, include a slower access medium (e.g., a hard disk drive) for an operating system. These computing devices may also implement standardized hardware platform interfaces for their operating systems, such as the Unified Extensible Firmware Interface (UEFI). However, UEFI often precludes the ability to implement write back caching during various portions of the boot process due to security features in UEFI. For instance, secure boot in UEFI prevents the loading of drivers or OS loaders that are not signed with an acceptable digital signature prior to the UEFI boot manager exiting the pre-OS portion of the boot process. This makes implementing write back caching in a UEFI boot environment problematic, as caching some boot data may render the computing device unbootable due to the security features in UEFI.

### SUMMARY

Write back caching of Operating System (OS) boot data in a UEFI environment is implemented differently depending on where in the UEFI boot process the boot data is accessed. One embodiment is an apparatus that includes a non-volatile memory, a storage device, and a processor. The non-volatile memory is operable to cache boot data for an OS. The storage device is operable to store the OS. The processor is operable to receive a write request for the storage device, to determine whether the write request modifies boot data accessed within a UEFI pre-OS boot environment. The processor is further operable to direct the write request to the storage device responsive to determining that the write request modifies boot data accessed within the UEFI pre-OS boot environment, and to direct the write request to the non-volatile memory responsive to determining that the write request does not modify boot data accessed within the UEFI pre-OS boot environment.

The various embodiments disclosed herein may be implemented in a variety of ways as a matter of design choice. For example, some embodiments herein are implemented in hardware whereas other embodiments may include processes that are operable to construct and/or operate the hardware. Other exemplary embodiments are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is an exemplary block diagram of a computing device for implementing write back caching of OS boot data in a UEFI environment.

FIG. 2 is an exemplary block diagram of a boot process in a UEFI environment.

FIG. 3 is an exemplary flow chart for implementing write back caching of OS boot data in a UEFI environment.

FIG. 4 is an exemplary I/O stack for implementing write back caching of OS boot data in a UEFI environment

FIG. 5 illustrates an exemplary computer system operable to execute programmed instructions to perform desired functions.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

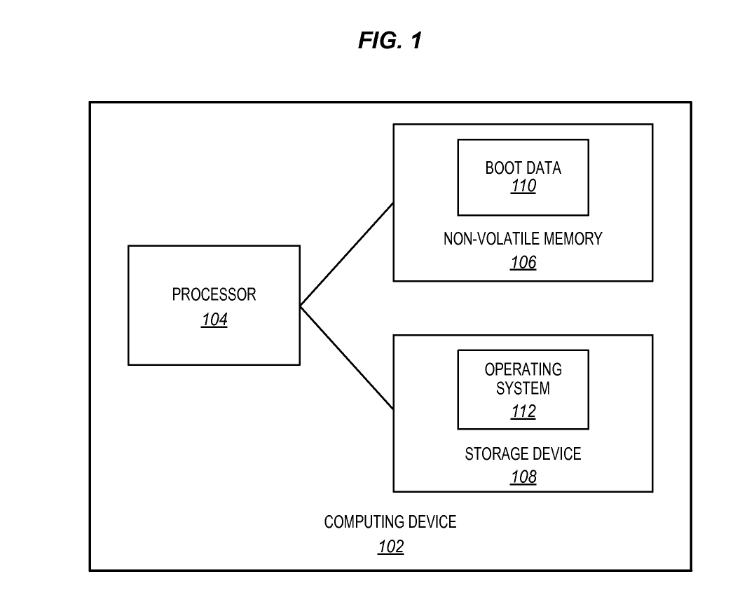

FIG. 1 is a block diagram of an exemplary computing device 102 for implementing write back caching of OS boot data in a UEFI environment. In this embodiment, computing device 102 is able to switch between write back mode and write through mode for write requests depending on where boot data modified by the write request is accessed in the boot process for a UEFI platform. For instance, if the write request modifies boot data early in the boot process while the UEFI boot manager is active, then computing device 102 may switch to write through mode to ensure that the UEFI boot manager has access to the most up-to-date boot data during the next boot cycle. However, if the write request modifies boot data later in the boot process, then computing device 102 may switch to write back mode to reduce the amount of time to boot the OS for computing device 102.

Computing device 102 may include a Personal Computer (PC), a tablet, a smart phone, etc. In this embodiment, computing device 102 includes a processor 104, a non-volatile memory 106, and a storage device 108. Processor 104 includes any component, system, or device that is able to execute instructions to perform the functionality described herein for computing device 102. Some examples of processor 104 include the ARM9™, the Intel® Core™ processor, the Intel® Pentium® processor, etc. Non-volatile memory 106 caches boot data 110 for an OS 112 that is stored on storage device 108. Boot data 110 includes any data from OS 112 that may be accessed during a boot process for computing device 102. Some examples of boot data 110 include drivers (e.g., storage drivers, network drivers, etc.), programs or services, etc., which are loaded during a boot process for computing device 102. Non-volatile memory 106 includes any component, system, or device that is able to store boot data 110 persistently. Some examples of non-volatile memory 106 include FLASH, battery backed Random Access Memory (RAM), a Solid State Disk (SSD), etc. Storage device 108 stores OS 112, which is loaded and executed during a boot process for computing device 102. Some examples of OS 112 include Windows®, Unix®, variants of Unix®, etc., while some examples of storage device 108 includes Hard Disk Drives, SSDs, etc.

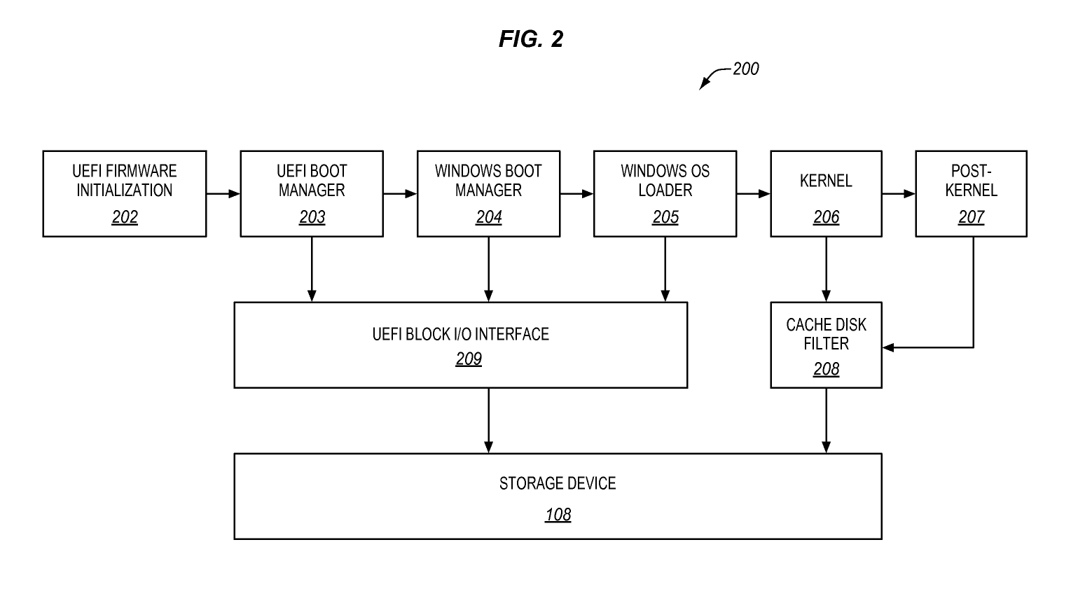

FIG. 2 is an exemplary block diagram 200 of a boot process in a UEFI environment. One example of a UEFI environment is computing device 102. Block diagram 200 illustrates just some of the phases or steps during a boot process, and one skilled in the art will recognize that other phases or steps may exist. Further, block diagram 200 illustrates a boot process for Windows® merely for purposes of discussion, and one skilled in the art will recognize that other operating systems and/or other versions of Windows® may be implemented differently.

One problem in implementing write back caching of OS 112 in a UEFI environment is how to ensure that cached versions of OS 112 (e.g., boot data 110) are accessible during the boot process. During the boot process for a UEFI platform, portions of the boot process are under the control of a UEFI boot manager 203, which accesses storage device 108 utilizing a UEFI block I/O interface 209. UEFI block I/O interface 209 is a collection of firmware routines for accessing block I/O devices, such as storage device 108. If, for example, storage device 108 has stale OS data due to write back caching of OS 112, then it is possible that the platform may not boot. Further, it is not a simple task to modify UEFI boot manager 203, since it is a firmware routine and it may also include a digital signature to prevent unauthorized changes. In addition, the secure boot process in UEFI, which is required for various versions of Windows®, prevents modification of Windows® boot manager 204, Windows® OS loader 205, and kernel 206 by signing them with digital signatures. Next, the various boot phases of block diagram 200 will be discussed.

An early phase of the boot process for a UEFI platform is a UEFI firmware initialization 202. In this phase, minimal resources are used on the platform to initialize the platform (e.g., initialize processor 104 on computing device 102).

In response to completing UEFI firmware initialization 202, UEFI boot manager 203 is in charge of loading Windows® boot manager 204 for OS 112. To do so, UEFI boot manager 203 utilizes UEFI block I/O interface 209 to read Windows® boot manager 204 from storage device 108 into memory (e.g., RAM). Since UEFI boot manager 203 utilizes the firmware UEFI block I/O interface 209 routines, it is not possible to intercept the loading of Windows® boot manager 204 to, for instance, utilize a cached copy of Windows® boot manager 204 stored by non-volatile memory 106. Once UEFI boot manager 203 loads Windows® boot manager 204, the boot process is transferred to Windows® boot manager 204.

Windows® boot manager 204 is in charge of loading Windows® OS loader 205 for OS 112. To do so, Windows® boot manager 204 utilizes UEFI block I/O interface 209 to read Windows® OS loader 205 from storage device 108 into memory (e.g., RAM). Since Windows® boot manager 204 utilizes the UEFI block I/O interface 209, it is not possible to intercept the loading of Windows® OS loader 205 to, for instance, utilize a cached copy of Windows® OS loader 205 stored by non-volatile memory 106. Further, Windows® boot manager 204 is digitally signed, and attempts to modify Windows® boot manager 204 to, for instance, utilize a cached copy of Windows® OS loader 205 will fail during a secure boot process. Once Windows® boot manager 204 loads Windows® OS loader 205, the boot process is transferred to Windows® OS loader 205.

Windows® OS loader 205 is in charge of loading kernel 206 of OS 112 and an I/O stack for storage device 108. To do so, Windows® OS loader 205 utilizes UEFI block I/O interface 209 to read kernel 206 from storage device 108 into memory (e.g., RAM). Since Windows® OS loader 205 utilizes the UEFI block I/O interface 209, it is not possible to intercept the loading of kernel 206 and the I/O stack to, for instance, utilize a cached copy of kernel 206 and/or the I/O stack stored by non-volatile memory 106. Further, Windows® OS loader 205 is digitally signed, and attempts to modify Windows® OS loader 205 to, for instance, utilize a cached copy of kernel 206 will fail during a secure boot process. Once Windows® OS loader 205 loads kernel 206, Windows® OS loader 205 will call a UEFI ExitBootServices( ) routine which ends the UEFI boot services phase of the boot process. Kernel 206 takes over the boot process at this point.

Kernel 206 does not utilize UEFI block I/O interface 209 to load additional device driver and system files, but instead utilizes the I/O stack for storage device 108 loaded by Windows® OS loader 205. In this embodiment, the I/O stack includes a cache disk filter 208, which may be implemented in function by processor 104. Cache disk filter 208 monitors I/O requests generated by kernel 206 (and any subsequent logon process that may be part of a post-kernel 207 environment, such as winlogon.exe, lsass.exe, etc.) for device drivers, system files, or other boot data, and determines whether the I/O request can be serviced by boot data 110 stored in non-volatile memory 106 or by OS 112 stored on storage device 108.

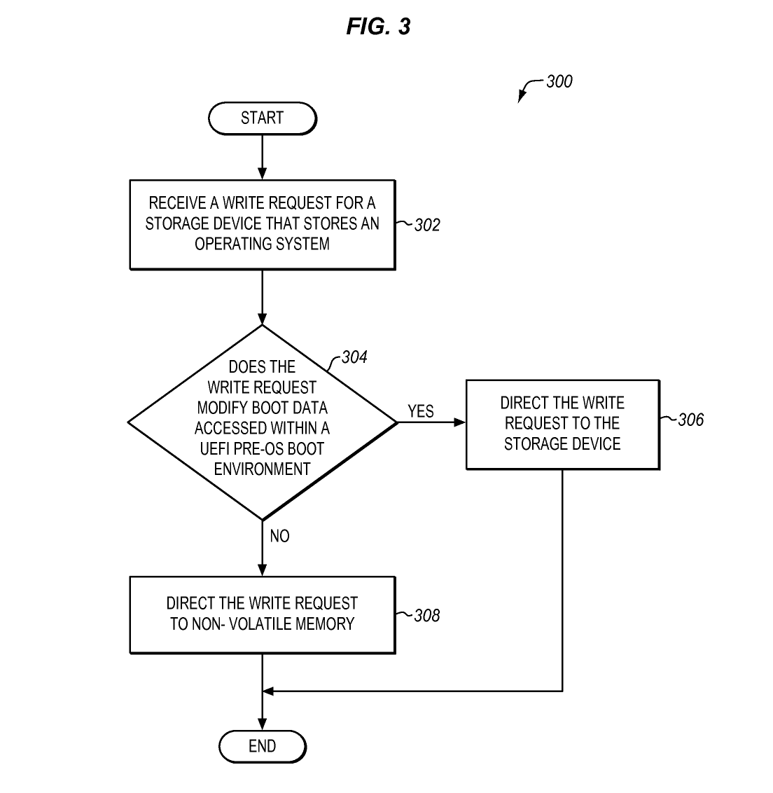

FIG. 3 is an exemplary flow chart of a method 300 for implementing write back caching of OS boot data in a UEFI environment. The steps of method 300 will be described with respect to computing device 102 of FIG. 1, although one skilled in the art will recognize that method 300 may be performed by other systems not shown. In addition, the steps of the flow charts shown herein are not all inclusive and other steps, not shown, maybe included. Further, the steps may be performed in an alternate order.

In response to the assembly of an I/O stack for storage device 108 by kernel 206, processor 104 implements the functionality of cache disk filter 208 to monitor write requests directed to storage device 108 and to implement other functionality described herein for cache disk filter 208. The write requests may be generated by kernel 206 after the assembly of the I/O stack or by post-kernel 207 processes that are executed after kernel 206 executes as part of the boot process for OS 112. Cache disk filter 208 may receive a write request for storage device 108, which stores OS 112 (see step 302 of FIG. 3). Cache disk filter 208 then analyzes the write request to determine if the request modifies boot data accessed within the UEFI pre-OS boot environment. Some examples of a write request that modifies boot data within the UEFI pre-OS boot environment for Windows® includes writes that modify bootmgfw.efi (Windows® boot manager 204), winload.efi (Windows® OS loader 205), ntoskrl.exe (kernel 206), and various device drivers that may be loaded by kernel 206 when assembling the I/O stack for storage device 108.

As discussed previously with respect to FIG. 2, portions of the boot process in a UEFI environment (e.g., the pre-OS environment) utilize UEFI block I/O interface 209 to access OS 112 on storage device 108. If this data is cached to non-volatile memory 106, then in the next boot cycle OS 112 will have stale data. This is problematic and may prevent computing device 102 from booting correctly. If cache disk filter 208 determines that the write request modifies boot data in the pre-OS boot environment, then cache disk filer 208 switches to write through mode and writes the request to storage device 108 (see step 306 of FIG. 3). This ensures that during the next boot cycle that the pre-OS boot data is up-to-date.

However, if cache disk filter 208 determines that the write request does not modify boot data in the pre-OS environment, then disk cache filter 208 directs the write request to non-volatile memory 106 and stores the write request as boot data 110. In the next boot cycle, disk cache filter 208 will be in place in the I/O stack to monitor read requests OS 112, and to potentially service read request utilizing boot data 110 stored in non-volatile memory 106. Utilizing boot data 110 cached in non-volatile memory 106 reduces the boot time for computing device 102.

How cache disk filter 208 may determine whether a write request for storage device 108 modifies boot data in the pre-OS boot environment is a matter of design choice, and one skilled in the art will recognize that a number of possibilities exist. In some embodiments, cache disk filter 208 may use Logical Block Address (LBA) information for boot files stored on storage device 108, with the LBAs being associated with boot files for OS 112 that are accessed within the pre-OS UEFI boot process. Using this type of information, cache disk filter 208 may then compare LBAs in the received write request for storage device 108 with the LBA information, thereby allowing cache disk filter 208 to determine if either a write through or write back mode of caching should be utilized based on where in the boot process the boot files are accessed. For example, if no LBAs in the write request correspond to the LBA information that was identified to be associated with boot files for OS 112 that are accessed within the pre-OS UEFI boot process, then cache disk filter 208 may switch to write back mode to speed up booting in the next boot cycle. But, for example, if LBAs in the write request correspond to the LBA information that was identified to be associated with boot files for OS 112 that are accessed within the pre-OS UEFI boot process, then cache disk filter 208 may switch to write through mode to ensure consistent boot data in the next boot cycle.

### EXAMPLE

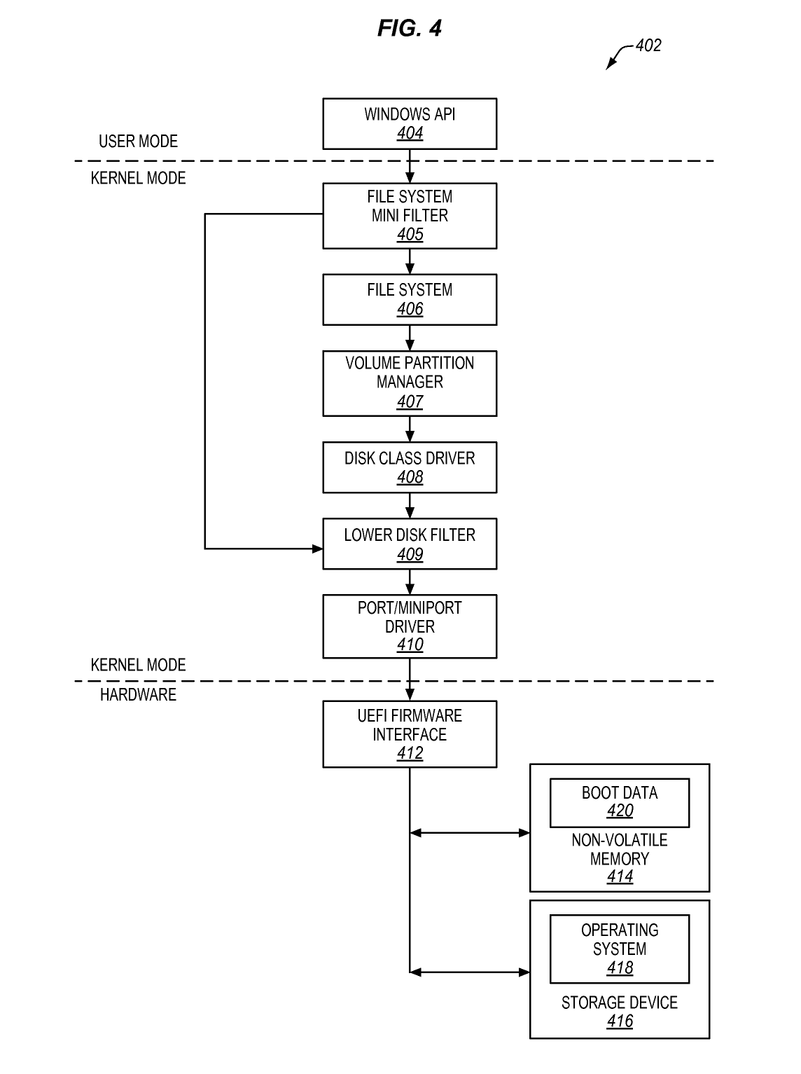

FIG. 4 is an exemplary I/O stack 402 for implementing write back caching of OS boot data in a UEFI environment. I/O stack 402 in this embodiment includes a Windows® API 404 layer that operates in user mode, and a file system mini filter 405 layer that operates in kernel mode. In this embodiment, file system mini filter 405 scans storage device 416 for boot files associated with operating system 418, and assembles LBA information for the boot files. In some cases, the LBA information will be associated with boot files for OS 418 that are accessed within the pre-OS boot environment. This information is provided to a lower disk filter 409 layer within I/O stack 402 to allow lower disk filter 409 to determine whether write requests are performed in a write through mode to storage device 416, or performed in a write back mode to boot data 420 stored on non-volatile memory 414. File system mini filter 405 keeps track of a database of boot file LBAs in case of a Windows® update, new driver installation, or relocation of boot files due to a disk defragmentation. File system mini filter 405 passes the updated LBA information to lower disk filter 409. In some embodiments, file system mini filter 405 may assemble LBA information for boot files of OS 418 that are not accessed within the pre-OS boot environment, and provide this information to lower disk filter 409. In either embodiment, the LBA information allows lower disk filter 409 to determine whether a write request modifies boot files for OS 418 that are accessed within the pre-OS boot environment or outside of the pre-OS boot environment.

Also part of I/O stack 402 between file system mini filter 405 and lower disk filter 409 is a file system 406 layer, a volume partition manager 407 layer, and a disk class driver 408 layer. A port/miniport driver 410 layer operates in kernel mode and resides between lower disk filter 409 and a hardware UEFI firmware interface 412 to both storage device 416 and non-volatile memory 414. The particular layers of I/O stack 402 are merely representative and more or fewer layers may exist depending on the type of OS 418 and the type of storage medium utilized for storage device 416 and/or non-volatile memory 414.

After I/O stack 402 is assembled during the boot process (e.g., by Windows® OS loader 205), write requests for storage device 416 either by kernel 206 and/or by post-kernel 207 processes utilize I/O stack 402 to access storage device 416. Lower disk filter 409 analyzes the write requests to determine whether the write request corresponds to boot files for OS 418 that are accessed within the pre-OS boot environment and therefore, would not be available in the next boot cycle prior to the assembly of I/O stack 402. In this case, lower disk filter 409 switches to write through mode and directs the write request to storage device 416. This ensures that prior to the assembly of I/O stack 402 in the next boot cycle OS 418 includes up to date information. For instance, driver updates to port/miniport driver 410 is not cacheable since port/miniport driver 410 is loaded as part of I/O stack 402 prior to initiating caching activities for I/O requests directed to storage device 416.

If lower disk filter 409 determines that a particular write request does not correspond to boot files for OS 418 that are accessed within the pre-OS boot environment, then lower disk filter 409 is able to cache this to non-volatile memory 414 for use during the next boot cycle. When a subsequent read request is received for OS 418, lower disk filter 406 is able to service the read request utilizing a fast access to non-volatile memory 414 rather than a slower access to storage device 416. This improves the boot time. For instance, driver updates to a network driver that is loaded after the assembly of I/O stack 402 is cacheable since I/O stack 402 would then be in place to not only cache updates to such a network driver to non-volatile memory 414, but also to subsequently service any read requests for such a network driver by reading non-volatile memory 414 rather than accessing storage device 416. Table 1 below illustrates various files for a Windows® implementation, and whether the files may be cacheable to non-volatile memory 414 (e.g., a write request utilizes write back mode with writes directed to non-volatile memory 414) or whether the files may not be cacheable to non-volatile memory 414 (e.g., a write request utilizes write through mode directed to storage device 416).

TABLE 1

| file | location | Boot stage | Caching mode |
|---|---|---|---|
| bootmgfw.efi | System UEFI partition | Pre-boot | Write through |
| winload.efi | System UEFI partition | Pre-boot | Write through |
| Winload.efi loads Boot- | Windows/system32/drivers | Pre-boot | Write through |
| start drivers(disk driver | | | |
| and other dependent | | | |
| driver for I/O stack and | | | |
| also our low level disk | | | |
| class filter caching | | | |
| driver (.sys) | | | |
| Ntdetect.com | System UEFI partition | Pre-boot | Write through |
| Ntoskrl.exe | Windows/system32 | Kernel load | Write through |
| hal.dll | Windows/system32 | Kernel load | Write through. |
| Ntoskml.exe | In-memory | Initialization | Start Caching in write |
| | | | back mode once I/O |
| | | | stack is up and |
| | | | initialized. |
| System-start drivers | Windows/system32/drivers | Initialization | Write back mode. |
| winlogon.exe & | Windows/system32 | Logon | Write back mode. |
| LSASS.EXE | | | |
| (whichdisplays logon | | | |
| dialogbox for user) | | | |
| network drivers & other | Windows/system32 | Logon | Write back mode. |
| drivers which gets | | | |
| loaded during | | | |
| logon (.sys) | | | |

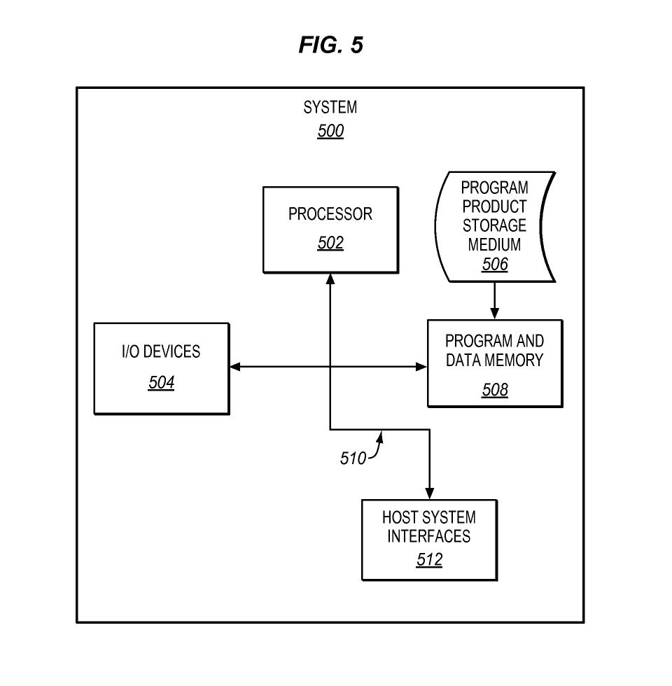

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. FIG. 5 illustrates system 500 in which a computer readable medium 506 may provide instructions for performing the methods disclosed herein.

Furthermore, the invention can take the form of a computer program product accessible from a computer-usable or computer-readable medium 506 providing program code for use by or in connection with a computer or any instruction execution system. For the purposes of this description, a computer-usable or computer readable medium 506 can be any apparatus that can contain, store, communicate, or transport the program for use by or in connection with the instruction execution system, apparatus, or device.

The medium 506 can be an electronic, magnetic, optical, electromagnetic, infrared, or semiconductor system (or apparatus or device). Examples of a computer-readable medium 506 include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 502 coupled directly or indirectly to memory elements 508 through a system bus 510. The memory elements 508 can include local memory employed during actual execution of the program code, bulk storage, and cache memories which provide temporary storage of at least some program code in order to reduce the number of times code is retrieved from bulk storage during execution.

Input/output or I/O devices 504 (including but not limited to keyboards, displays, pointing devices, etc.) can be coupled to the system either directly or through intervening I/O controllers.

Network adapters may also be coupled to the system to enable the data processing system to become coupled to other data processing systems, such as through host systems interfaces 512, or remote printers or storage devices through intervening private or public networks. Modems, cable modem and Ethernet cards are just a few of the currently available types of network adapters.

What is claimed is:

1. An apparatus comprising:
a non-volatile memory operable to cache boot data for an Operating System (OS);
a storage device operable to store the OS; and
a processor operable to receive a write request for the storage device, to determine whether the write request modifies boot data accessed within a Unified Extensible Firmware Interface (UEFI) pre-OS boot environment, and to:
direct the write request to the storage device responsive to determining that the write request modifies boot data accessed within the UEFI pre-OS boot environment; and
direct the write request to the non-volatile memory responsive to determining that the write request does not modify boot data accessed within the UEFI pre-OS boot environment.

2. The apparatus of claim 1 wherein:
the UEFI pre-OS boot environment comprises boot data accessed prior to a UEFI ExitBootServices( ) function.

3. The apparatus of claim 1 wherein:
the storage device is a Hard Disk Drive; and
the non-volatile memory is a Solid State Disk.

4. The apparatus of claim 1 wherein:
the processor is further operable to identify an OS boot file on the storage device accessed within the UEFI pre-OS boot environment, to identify Logical Block Addresses (LBAs) for the boot file, and to determine that the write request modifies boot data accessed within the UEFI pre-OS boot environment if at least one LBA for the boot file corresponds to an LBA for the write request.

5. The apparatus of claim 1 wherein:
the processor is further operable to identify OS boot files on the storage device accessed within the UEFI pre-OS boot environment, to identify Logical Block Addresses (LBAs) for the boot files, and to determine that the write request does not modify boot data accessed within the UEFI pre-OS boot environment if no LBAs for the boot files corresponds to LBAs for the write request.

6. The apparatus of claim 1 wherein:
the processor is further operable to identify an OS boot file on the storage device accessed outside of the UEFI pre-OS boot environment, to identify Logical Block Addresses (LBAs) for the boot file, and to determine that the write request does not modify boot data accessed within the UEFI pre-OS boot environment if at least one LBA for the boot file corresponds to an LBA for the write request.

7. The apparatus of claim 1 wherein:
the processor is further operable to identify OS boot files on the storage device accessed outside of the UEFI pre-OS boot environment, to identify Logical Block Addresses (LBAs) for the boot files, and to determine that the write request does not modify boot data accessed within the UEFI pre-OS boot environment if no LBAs for the boot files corresponds to LBAs for the write request.

8. A method comprising:
receiving a write request for a storage device that stores an Operating System (OS);
determining whether the write request modifies boot data accessed within a Unified Extensible Firmware Interface (UEFI) pre-OS boot environment;
directing the write request to the storage device responsive to determining that the write request modifies boot data accessed within the UEFI pre-OS boot environment; and
directing the write request to a non-volatile memory that caches boot data for the OS responsive to determining that the write request does not modify boot data accessed within the UEFI pre-OS boot environment.

9. The method of claim 8 wherein:
the UEFI pre-OS boot environment comprises boot data accessed prior to a UEFI ExitBootServices( ) function.

10. The method of claim 8 wherein:
the storage device is a Hard Disk Drive; and
the non-volatile memory is a Solid State Disk.

11. The method of claim 8 wherein:
the method further comprises:
identifying an OS boot file on the storage device accessed within the UEFI pre-OS boot environment; and
identifying Logical Block Addresses (LBAs) for the boot file; and
determining whether the write request modifies boot data further comprises:
determining that the write request modifies boot data accessed within the UEFI pre-OS boot environment if at least one LBA for the boot file corresponds to an LBA for the write request.

12. The method of claim 8 wherein:
the method further comprises:
identifying OS boot files on the storage device accessed within the UEFI pre-OS boot environment; and
identifying Logical Block Addresses (LBAs) for the boot files; and
determining whether the write request modifies boot data further comprises:
determining that the write request does not modify boot data accessed within the UEFI pre-OS boot environment if no LBAs for the boot files corresponds to LBAs for the write request.

13. The method of claim 8 wherein:
the method further comprises:
identifying an OS boot file on the storage device accessed outside of the UEFI pre-OS boot environment; and
identifying Logical Block Addresses (LBAs) for the boot file; and
determining whether the write request modifies boot data further comprises:
determining that the write request does not modify boot data accessed within the UEFI pre-OS boot environment if at least one LBA for the boot file corresponds to an LBA for the write request.

14. The method of claim 8 wherein:
the method further comprises:
identifying OS boot files on the storage device accessed outside of the UEFI pre-OS boot environment; and
identifying Logical Block Addresses (LBAs) for the boot files; and
determining whether the write request modifies boot data further comprises:
determining that the write request does not modify boot data accessed within the UEFI pre-OS boot environment if no LBAs for the boot files corresponds to LBAs for the write request.

15. A non-transitory computer readable medium embodying instructions which, when executed by a processor, direct the processor to:
receive a write request for a storage device that stores an Operating System (OS);
determine whether the write request modifies boot data accessed within a Unified Extensible Firmware Interface (UEFI) pre-OS boot environment;
direct the write request to the storage device responsive to determining that the write request modifies boot data accessed within the UEFI pre-OS boot environment; and
direct the write request to a non-volatile memory that caches boot data for the OS responsive to determining that the write request does not modify boot data accessed within the UEFI pre-OS boot environment.

16. The non-transitory computer readable medium of claim 15 wherein:
the UEFI pre-OS boot environment comprises boot data accessed prior to a UEFI ExitBootServices( ) function.

17. The non-transitory computer readable medium of claim 15 wherein:
the instructions further direct the processor to:
identify an OS boot file on the storage device accessed within the UEFI pre-OS boot environment; and
identify Logical Block Addresses (LBAs) for the boot file; and
instructions that direct the processor to determine whether the write request modifies boot data further comprise instructions that direct the processor to:
determine that the write request modifies boot data accessed within the UEFI pre-OS boot environment if at least one LBA for the boot file corresponds to an LBA for the write request.

18. The non-transitory computer readable medium of claim 15 wherein:
the instructions further direct the processor to:
identify OS boot files on the storage device accessed within the UEFI pre-OS boot environment; and
identify Logical Block Addresses (LBAs) for the boot files; and
instructions that direct the processor to determine whether the write request modifies boot data further comprise instructions that direct the processor to:
determine that the write request does not modify boot data accessed within the UEFI pre-OS boot environment if no LBAs for the boot files corresponds to LBAs for the write request.

19. The non-transitory computer readable medium of claim 15 wherein:
the instructions further direct the processor to:
identify an OS boot file on the storage device accessed outside of the UEFI pre-OS boot environment; and
identify Logical Block Addresses (LBAs) for the boot file; and
instructions that direct the processor to determine whether the write request modifies boot data further comprise instructions that direct the processor to:
determine that the write request does not modify boot data accessed within the UEFI pre-OS boot environment if at least one LBA for the boot file corresponds to an LBA for the write request.

20. The non-transitory computer readable medium of claim 15 wherein:
the instructions further direct the processor to:
identify OS boot files on the storage device accessed outside of the UEFI pre-OS boot environment; and
identify Logical Block Addresses (LBAs) for the boot files; and
instructions that direct the processor to determine whether the write request modifies boot data further comprise instructions that direct the processor to:
determine that the write request does not modify boot data accessed within the UEFI pre-OS boot environment if no LBAs for the boot files corresponds to LBAs for the write request.
